(19) United States
(12) Patent Application Publication
(10) Pub. No.: US 2025/0329824 A1
(43) Pub. Date: Oct. 23, 2025

(54) AUTOCLAVABLE BATTERY WITH THERMAL SWITCH

(71) Applicant: Medtronic, Inc., Minneapolis, MN (US)

(72) Inventors: Eric I. Hanson, Maple Grove, MN (US); Parthasarathy M. Gomadam, Plymouth, MN (US); Erik J. Hovland, Minnetonka, MN (US); Laura E. McCalla, Brossard (CA)

(21) Appl. No.: 19/185,980

(22) Filed: Apr. 22, 2025

Related U.S. Application Data
(60) Provisional application No. 63/637,694, filed on Apr. 23, 2024.

(51) Int. Cl. H01M 10/658; H01M 10/653; H01M 50/213; H01M 50/227

(52) U.S. Cl. CPC H01M 10/658; H01M 10/653; H01M 50/213; H01M 50/227

(57) ABSTRACT

Systems and methods for electrochemical cells, or batteries, wherein the batteries include at least a first inner shell, a second outer shell, and a pin, wherein each of the first inner shell, second outer shell, and pin are thermally conductive. Under most operating temperatures the pin thermally couples the first shell to the second shell. The batteries include at least one thermally expansive component, which may be one of the shells that expands when the battery is exposed to elevated temperatures. As temperatures rise, the expansive component expands such that the pin no longer thermally couples the first and second shells, thereby disconnecting the path of heat flow from an external heat source to inside the electrochemical cell and thereby preventing cell damage. A spring may be included to ensure robust thermal coupling between the first and second shell during normal operating temperatures.

### RELATED APPLICATIONS

This application claims the benefit of U.S. Provisional Application Ser. No. 63/637,694, filed Apr. 23, 2024, the entire contents of each of which are incorporated herein by reference.

### SUMMARY

The present disclosure generally relates to systems and methods for batteries or electrochemical cells which include at least one thermal switch, particularly in order to protect from elevated external temperatures, such as those associated with an autoclave sterilization process.

### BACKGROUND

Batteries, or electrochemical cells, generally perform better in moderate temperature ranges. Exposure to high temperatures can adversely affect the integrity of the electrochemical cells in a plurality of ways, including increased chemical reactions inside the cells which causes battery degradation and ultimately, anything from a shorter battery lifespan to irreversible damage. Therefore, it is advantageous to keep batteries, or electrochemical cells, insulated from exposure to irreversible heat damage.

Medical devices regularly use rechargeable battery packs. Given how expensive batteries are to produce, purchase, and safely dispose of, it may be more preferable to use rechargeable batteries rather than single use primary cell batteries. However, to comply with sanitary requirements in hospital settings, it may be desirable for any non-single use equipment to be sterilized prior to reuse. For medical devices and their related components, often, sterilization requirements include exposure to elevated temperatures and pressures, such as those associated with an autoclave process.

As an example, for rechargeable batteries, requirements for sterilization include at least clearing away debris, dust, or any other accumulation that may have pooled over the exterior layer. Then, deep sterilization through an autoclave process may be desirable. An example autoclave process can comprise subjecting equipment to pressurized saturated steam ranging from 121° C. to 138° C. anywhere from 15 to 60 minutes, depending on the size of the load of equipment subjected to the autoclave process, and then allowing for drying time of the equipment.

Autoclave processes are generally gentle enough to not adversely affect equipment hardware. However, for medical devices making use of batteries, the heat exposure from the autoclave steam can often result in degradation of battery performance and battery life. And yet, to comply with certain healthcare protocols, it may be desirable to sterilize all medical equipment, including batteries, by known and accepted sterilization methods. Therefore, it is desirable to protect batteries from the heat of an autoclave process without affecting the integrity of the autoclave process itself.

Described herein are systems and methods for batteries or electrochemical cells which include at least one thermal switch, particularly in order to protect from elevated external temperatures, such as those associated with an autoclave sterilization process. The thermal switch may be configured to transfer internal heat generated by the battery to the external environment under general operating conditions and to prevent transfer of heat from the external environment into the battery at elevated external temperatures.

A first illustrative aspect of a battery comprises a thermally conductive outer shell formed from a first material having a first coefficient of thermal expansion (CTE); a thermally conductive inner shell disposed in the outer shell, wherein the inner shell is formed of a second material having a second CTE lower than the first CTE; an electrochemical cell disposed in the inner shell; and a thermally conductive pin fixed relative to the outer shell and positioned to couple to the inner shell at a first ambient temperature, wherein the battery is configured such that as ambient temperature increases the outer shell (i) expands to a greater degree than the inner shell, (ii) separates from the inner shell, and (iii) pulls the pin away from the inner shell.

In some embodiments, the battery is configured such that as ambient temperature decreases the outer shell (i) retracts to a greater degree than the inner shell, (ii) moves closer to the inner shell, and (iii) pushes the pin toward the inner shell.

In some embodiments, the battery is configured such that the pin thermally couples the outer shell to the inner shell at ambient temperatures of 100 degrees Celsius and below.

In some embodiments, the battery is configured such that expansion of the outer shell causes the pin to separate from the inner shell at ambient temperatures of greater than 100 degrees Celsius.

In some embodiments, the battery further comprises a thermally conductive spring. The spring may be coupled to the outer shell such that, as ambient temperature increases, the outer shell (i) expands, (ii) pulses against the spring, (iii) separates from the inner shell, and (iv) pulls the pin away from the inner shell.

In some embodiments, the battery is configured such that, as ambient temperature decreases, the outer shell (i) retracts, (ii) moves closer to the inner shell, and (iii) pushes the pin toward the inner shell.

In some embodiments, the battery further comprises a thermally conductive spring. The spring is coupled to the inner shell such that, as ambient temperature increases, (i) the outer shell expands, pulsing the pin against the spring, (ii) separates from the inner shell, and (iii) pulls the pin away from the inner shell.

In some embodiments, the battery is configured such that, as ambient temperature decreases, the outer shell (i) retracts, (ii) couples to the inner shell, and (iii) pushes the pin toward the inner shell.

In some embodiments, further comprising a thermally insulative layer disposed about the outer housing.

In some embodiments, the battery further comprises at least one connection terminal electronically accessible from outside the enclosure.

In some embodiments, the battery further comprises wherein the first CTE is at least 1 μm/m° C. greater than the second CTE.

In some embodiments, the first material comprises any of following materials: polycarbonate, acrylonitrile butadiene styrene, acrylonitrile butadiene styrene (ABS), acetals, acrylic, benzocylcobutene, cellulose acetate (CA), cellulose acetate butynate (CAB), cellulose nitrate (CN), fluorinated ethylene propylene (FEP), nylon, polyacrylonitrile, polyamide (PA), polybutylene (PB), polycarbonate (PC), polyester, polyethylene terephthalate (PET), polyphenylene, polystyrene, polytetrafluoroethylene (PFTE), polyurethane, polyvinylchloride, polyvinylidene fluoride, polyimide (PI), polyphenylene sulfide (PPS), polyaryletherketone (PAEK), and polyetheretherketone (PEEK).

In some embodiments, the the second material comprises any of the following materials: aluminum, aluminum nitride, aluminum alloy, silicon carbide, ALLVAR Alloy 30, titanium, titanium alloy, stainless steel, nickel, nickel alloy, a ceramic material, and a plastic. In some embodiments, the CTE of the first material is between 20 μm/m° C. and 400 μm/m° C.

In some embodiments, the CTE of the second material is between −20 μm/m° C. and 20 μm/m° C.

A second illustrative aspect of a battery comprises a thermally conductive outer shell formed from a first material having a first coefficient of thermal expansion (CTE); a thermally conductive inner shell disposed in the outer shell formed from a second material having a second CTE; an electrochemical cell disposed in the inner shell; a thermally conductive pin coupled to the outer shell; a spring coupled to the inner shell; at least a first non-thermally conductive expansion element fixed relative to the outer shell and configured to expand toward the inner shell having a third CTE, wherein the third CTE is greater than the first CTE and second CTE; and a flange, configured to couple the pin, the expansion element, and the spring at a first ambient temperature, such that the resulting coupling couples the inner shell to the outer shell; wherein the battery is configured such that as ambient temperature increases the expansion element (i) expands, (ii) presses against the flange, (iii) causes the spring to separate from the pin, and (iv) uncouples the inner shell from the outer shell.

In some embodiments, the battery is configured such that as ambient temperature decreases the expansion element (i) retracts to a greater degree than the inner shell and the outer shell (ii) moves the pin closer to the spring, and (iii) couples the spring to the pin.

In some embodiments, the battery is configured such that the pin thermally couples to the spring at ambient temperatures of 100 degrees Celsius and below.

In some embodiments, the battery is configured such that expansion of the outer shell causes the pin to separate from the spring at ambient temperatures of greater than 100 degrees Celsius.

In some embodiments, further comprising a thermally insulative layer disposed about the outer housing.

In some embodiments, the battery further comprises at least one connection terminal electronically accessible from outside the enclosure.

In some embodiments, the first CTE is at least 1 μm/m° C. greater than the second CTE.

In some embodiments, the first CTE is the same as the second CTE.

In some embodiments, the first material comprises any of following materials: polycarbonate, acrylonitrile butadiene styrene, acrylonitrile butadiene styrene (ABS), acetals, acrylic, benzocylcobutene, cellulose acetate (CA), cellulose acetate butynate (CAB), cellulose nitrate (CN), fluorinated ethylene propylene (FEP), nylon, polyacrylonitrile, polyamide (PA), polybutylene (PB), polycarbonate (PC), polyester, polyethylene terephthalate (PET), polyphenylene, polystyrene, polytetrafluoroethylene (PFTE), polyurethane, polyvinylchloride, polyvinylidene fluoride, polyimide (PI), polyphenylene sulfide (PPS), polyaryletherketone (PAEK), polyetheretherketone (PEEK), and any combination thereof.

In some embodiments, the second material comprises any of the following materials: aluminum, aluminum nitride, aluminum alloy, silicon carbide, ALLVAR Alloy 30, titanium, titanium alloy, stainless steel, nickel, nickel alloy, a ceramic material, a plastic, and any combination thereof.

In some embodiments, the CTE of the first material is between 20 μm/m° C. and 400 μm/m° C.

In some embodiments, the CTE of the second material is between −20 μm/m° C. and 20 μm/m° C.

In some embodiments, the CTE of the expansion element can be between −10 μm/m° C. and 400 82 m/m° C.

In some embodiments, the pin comprises the flange. In some embodiments, the spring comprises the flange.

In some embodiments, the the pin is detachably coupled to the outer shell.

In some embodiments, the pin is fixed relative to the outer shell.

In some embodiments, the spring is detachably coupled to the inner shell.

In some embodiments, the spring is fixed relative to the inner shell.

A third illustrative aspect of a battery comprises a thermally conductive outer shell formed from a first material having a first coefficient of thermal expansion (CTE); a thermally conductive inner shell disposed in the outer shell formed from a second material having a second CTE; an electrochemical cell disposed in the inner shell; a thermally conductive pin detachably coupled to the outer shell; a spring portion coupled to the inner shell; at least a first non-thermally conductive expansion element fixed relative to the outer shell and configured to expand toward the inner shell having a third CTE, wherein the third CTE is greater than the first CTE and second CTE; and a flange, configured to couple the pin, the expansion element, and the spring portion at a first ambient temperature, such that the resulting coupling couples the inner shell to the outer shell; wherein the battery is configured such that as ambient temperature increases the expansion element (i) expands, (ii) presses against the flange, (iii) causes the pin to separate from the outer shell, and (iv) uncouples the inner shell from the outer shell.

In some embodiments, the battery is configured such that as ambient temperature decreases the expansion element (i) retracts to a greater degree than the inner shell and the outer shell (ii) moves the pin closer to the outer shell, and (iii) couples the spring to the outer shell.

In some embodiments, the battery is configured such that the pin thermally couples to the outer shell at ambient temperatures of 100 degrees Celsius and below.

In some embodiments, the battery is configured such that expansion of the outer shell causes the pin to separate from the outer shell at ambient temperatures of greater than 100 degrees Celsius.

In some embodiments, further comprising a thermally insulative layer disposed about the outer housing.

In some embodiments, the battery further comprises at least one connection terminal electronically accessible from outside the enclosure.

In some embodiments, the first CTE is at least 1 μm/m° C. greater than the second

CTE.

In some embodiments, the first CTE is the same as the second CTE.

In some embodiments, the first material comprises any of following materials: polycarbonate, acrylonitrile butadiene styrene, acrylonitrile butadiene styrene (ABS), acetals, acrylic, benzocylcobutene, cellulose acetate (CA), cellulose acetate butynate (CAB), cellulose nitrate (CN), fluorinated ethylene propylene (FEP), nylon, polyacrylonitrile, polyamide (PA), polybutylene (PB), polycarbonate (PC), polyester, polyethylene terephthalate (PET), polyphenylene, polystyrene, polytetrafluoroethylene (PFTE), polyurethane, polyvinylchloride, polyvinylidene fluoride, polyimide (PI), polyphenylene sulfide (PPS), polyaryletherketone (PAEK), polyetheretherketone (PEEK), and any combination thereof.

In some embodiments, the second material comprises any of the following materials: aluminum, aluminum nitride, aluminum alloy, silicon carbide, ALLVAR Alloy 30, titanium, titanium alloy, stainless steel, nickel, nickel alloy, a ceramic material, a plastic, and any combination thereof.

In some embodiments, the CTE of the first material can be between 20 μm/m° C. and 400 μm/m° C.

In some embodiments, the CTE of the second material can be between −20 μm/m° C. and 20 μm/m° C.

In some embodiments, the pin comprises the flange.

In some embodiments, the spring comprises the flange.

In some embodiments, the pin is detachably coupled to the outer shell.

In some embodiments, the pin is fixed relative to the outer shell.

In some embodiments, the spring is detachably coupled to the inner shell.

In some embodiments, the spring is fixed relative to the inner shell.

In some embodiments, the pin comprises the spring portion.

Advantages and additional features of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### BRIEF DESCRIPTION OF THE DRAWINGS

The following detailed description of specific embodiments of the present disclosure can be best understood when read in conjunction with the following drawings, in which:

FIGS. 1A-1B are schematic representations, respectively, of a battery where there is no gap is present between an inner shell and a pin associated with an outer shell and where a gap is present between the inner shell and the pin;

FIG. 2 is a thermal modelling data plot showing maximum coil temperature vs fraction of surface area of inner shell contacted with a thermally conductive copper pin at an applied load of 40 watts, 20 watts, and 10 watts;

FIGS. 3A-3C are perspective views of a battery, or components thereof, with a thermal switch;

FIG. 4 is a cross sectional view of an embodiment of a battery as depicted in FIGS. 3A-C;

FIGS. 5A-5C are schematic representations of an embodiment where the pin comprises a thermally conductive material; and

The drawings are not necessarily to scale.

### DETAILED DESCRIPTION

Reference will now be made in greater detail to various embodiments of the subject matter of the present disclosure, some embodiments of which are illustrated in the accompanying drawings. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components.

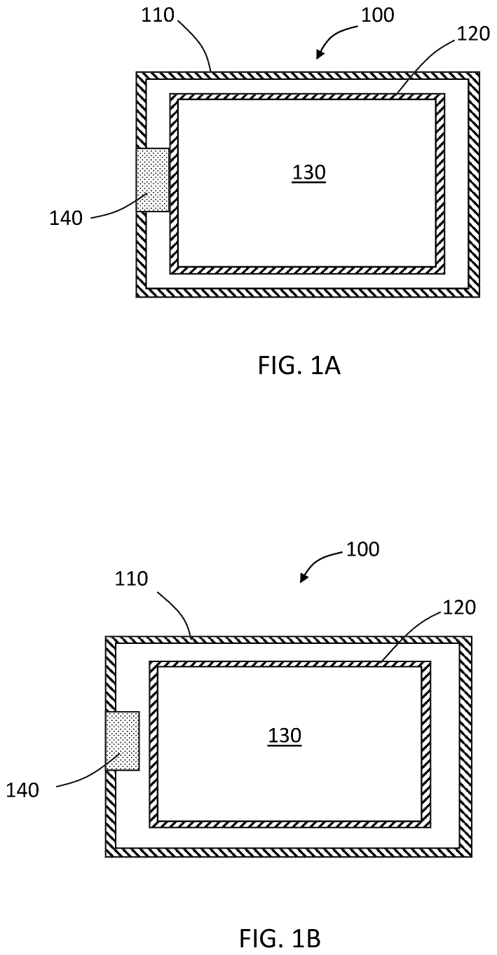

Referring to FIGS. 1A-B, a battery 100 includes a thermally conductive outer shell 110 formed from material having a first coefficient of thermal expansion (CTE) and a thermally conductive inner shell 120 disposed in the outer shell 110. The inner shell 120 is formed of a material having a second CTE lower than the first CTE. An electrochemical cell 130 is disposed in the inner shell 120. A thermally conductive pin 140 is fixed relative to the outer shell 110 and positioned to couple to the inner shell 120 at a first ambient temperature as depicted in FIG. 1A. As ambient temperature increases the outer shell 110 (i) expands to a greater degree than the inner shell 120, (ii) separates from the inner shell 120, and (iii) pulls the pin 140 away from the inner shell 140 as depicted in FIG. 1B. As ambient temperature decreases the outer shell 110 (i) retracts to a greater degree than the inner shell 110, (ii) moves closer to the inner shell 110, and (iii) pushes the pin 140 toward the inner shell 120 such that the pin 140 thermally couples the inner shell 120 and the outer shell 110 as depicted in FIG. 1A.

Accordingly, the thermally conductive pin 140 is in thermal contact with the outer shell 110 and the inner shell 120 when the battery 100 is exposed to ambient temperatures and transfers internal heat generated by the electrochemical cell 130 during use or recharge to be transferred to the external environment (outside of outer shell 110). When the battery 100 is exposed to elevated external temperatures, the pin 140 separates from the internal shell 120 so that external heat is not transferred directly to the internal shell 120, protecting the electrochemical cell 130 from the external heat.

The battery 100 may be configured such that the pin 140 separates from the inner shell 120 at any suitable temperature. For example, the battery 100 may be configured such that the pin 140 separates from the inner shell 120 when the battery 100 is exposed over a period of time to an external temperature of 85 degrees C. or greater. Example external temperatures which may trigger such separation may include at least an external temperature of 90 degrees C. or greater, 95 degrees C. or greater, 100 degrees C. or greater, 105 degrees C. or greater, 110 degrees C. or greater, 115 degrees C. or greater, or 120 degrees C. or greater.

By decoupling the pin 140 from the inner shell 120 at elevated temperatures, temperatures in the electrochemical cell 130 may increase more slowly when the battery 100 is exposed to the elevated temperatures. It should be understood that the thermal switch described herein (coupling and decoupling of the pin 140 from the inner shell 120) may protect the electrochemical cell from any environment in which the battery 100 is exposed to elevated temperatures, which is not limited to autoclave sterilization processes. For example, the thermal switch mechanism described herein may protect the electrochemical cell 130 in situations in which the battery 100 (or device comprising the battery 100) is sitting in the sun, in a trunk stock, or in another industrial or natural environment wherein the temperature is greater than, for example, 100 degrees C. for periods of time.

As the external temperature to which the battery 100 is exposed decreases (e.g., the temperature decreases to 120 degrees C. or less, 115 degrees C. or less, 110 degrees C. or less, 105 degrees C. or less, or 100 degrees C. or less, 95 degrees C. or less, 90 degrees C. or less, or 85 degrees C. or less), the outer shell 110 may retract more rapidly than the inner shell 120, moving the pin 140 closer to the inner shell 120 until the pin 140 contacts the inner shell 120 and thermally recouples the outer shell 110 to the inner shell 120, allowing internal heat generated by the electrochemical cell 130 to be transferred to the external environment.

The outer shell 110 may have any suitable coefficient of thermal expansion (CTE) provided that it has a CTE that is greater than the CTE of the inner shell 120. In some embodiments, the CTE of the outer shell is at least 1 μm/m° C. greater than a CTE of inner shell 120. In some embodiments, the CTE of the outer shell 110 is at least 20 μm/m° C. greater than the CTE of the inner shell 120. In some embodiments, the outer shell 110 has a CTE in a range from at least 60 μm/m° C. to 400 μm/m° C. In some embodiments, the outer shell 110 comprises, consists essentially of, or consists of PC/ABS, which has a CTE value of about 60 μm/m° C. In some embodiments, the inner shell 110 has a CTE of 25 μm/m° C. or less. In some embodiments, the inner shell 110 has a CTE of 22 μm/m° C. or less, such as 0 μm/m° C. to 22 μm/m° C., or −20 μm/m° C. to 22 μm/m° C. Any suitable material can comprise the inner shell 110, such as, for example, aluminum, ceramics, and metals.

In some embodiments, the outer shell 110 and the inner shell 120 are formed materials having similar thermally conductivities. In some embodiments, the outer shell 110 and the inner shell 120 are formed materials having thermally conductivities that are not similar. In some embodiments, the outer shell 110 has a thermal conductivity of 5 W/mK or greater. In some embodiments, the outer shell 110 has a thermal conductivity of at least 237 W/mK (e.g., aluminum). In some embodiments, the outer shell 110 has a thermal conductivity of at least 400 W/mK (e.g., copper). In some embodiments, the inner shell 120 has a thermal conductivity in the range between approximately 14 W/mK to 20 W/mK (e.g., stainless steel). In some embodiments, the inner shell 120 has a thermal conductivity of approximately 90 W/mK (e.g., nickel).

The outer shell 110 may be formed from any suitable material. In some embodiments, the outer shell 110 is formed from one or more polymeric materials. In some embodiments, the outer shell 110 is formed from one or more plastic materials. In some embodiments, outer shell 110 comprises polycarbonate, acrylonitrile butadiene styrene, or a combination thereof. In some embodiments, the outer shell 110 comprises any of acrylonitrile butadiene styrene (ABS), acetals, acrylic, benzocylcobutene, cellulose acetate (CA), cellulose acetate butynate (CAB), cellulose nitrate (CN), fluorinated ethylene propylene (FEP), nylon, polyacrylonitrile, polyamide (PA), polybutylene (PB), polycarbonate (PC), polyester, polyethylene terephthalate (PET), polyphenylene, polystyrene, polytetrafluoroethylene (PFTE), polyurethane, polyvinylchloride, polyvinylidene fluoride, polyimide (PI), polyphenylene sulfide (PPS), polyaryletherketone (PAEK), polyetheretherketone (PEEK), or any combination thereof.

The inner shell 120 may be formed from any suitable material. In some embodiments, the inner shell 120 is formed from one or more metallic materials. In some embodiments, the inner shell 120 is formed from aluminum. In some embodiments, the inner shell 120 is formed from aluminum nitride, silicon carbide, or ALLVAR Alloy 30. In some embodiments, the inner shell 120 comprises any of aluminum alloys, titanium, titanium alloys, stainless steels, nickel, nickel alloys, a plastic, a ceramic material, or any combination thereof.

The pin 140 may be formed from any suitable material. In some embodiments, the pin 140 is formed from a material having a thermal conductivity of 10 W/mK or greater. In some embodiments, the pin 140 is formed from a material having a thermal conductivity of between 20 W/mK and 400 W/mK. In some embodiments, the pin 140 comprises copper. In some embodiments, the pin 140 comprises aluminum nitride. In some embodiments, the pin 140 comprises nickel, titanium, aluminum, alloys, and any combination thereof.

Table 1, shown below, provides an example embodiment wherein the outer shell 110 comprises a blend polycarbonate acrylonitrile butadiene styrene (PC/ABS), the inner shell 120 comprises aluminum (Al), and the pin 140 comprises copper (Cu). Each CTE corresponding to each example material and expansion length of each material at different temperature points is also provided.

TABLE 1
Example CTEs and dimensions at different temperatures

| | | | CTE, | | | t = 135° C. | delta T |
|---|---|---|---|---|---|---|---|
| | t = 20° C. | | micrometer/ | delta | delta L, | dim hot, | autoclave, |
| | dim 1, in | dim 2, m | m-° C. | L, mm | in | in | ° C. |
| outer | 1.4120 | 0.0358648 | 60 | 236.71 | 0.00932 | 1.4213 | 110 |
| housing, | | | | | | | |
| PC/ABS | | | | | | | |
| inner | 1.3495 | 0.0342773 | 22 | 82.95 | 0.00327 | 1.3528 | |
| housing, | | | | | | | |
| AL | | | | | | | |
| pin, Cu | 0.0625 | 0.0015875 | 16 | 2.79 | 0.00011 | 0.0626 | |
| Gap at | 0.0059 | | | | | | |
| 135° C., | | | | | | | |
| inches | | | | | | | |

* Need higher CTE on outer enclosure, lower CTE on inner enclosure and pin to maximize gap at 135° C.
* Pin is in contact with inner housing at room temperature

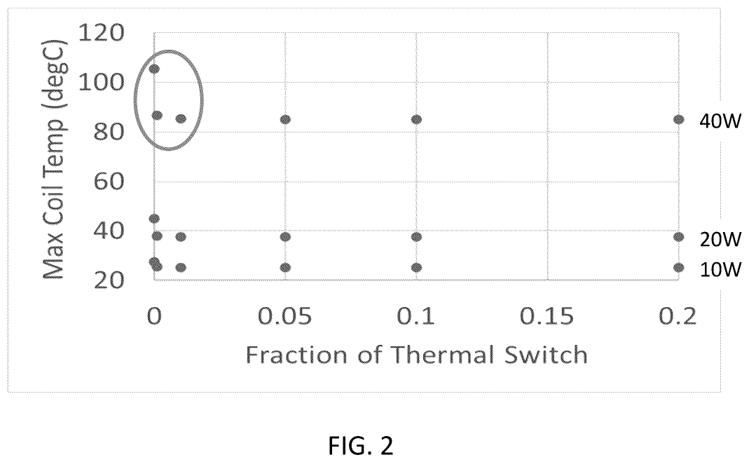

As illustrated in FIG. 2, even minimal contact between an inner shell (e.g., inner shell 120 of battery 100 of FIG. 1) and an example copper thermal pin (e.g., pin 140 of FIG. 1) (where minimal contact can be considered as less than 1% of the total inner shell 120 surface area) can reduce the inner electrochemical cell (e.g., electrochemical cell 130 as depicted in FIG. 1) temperature by about 20° C. under high power loads. Specifically, the circled data in FIG. 2 refers to a 40-watt applied power load.

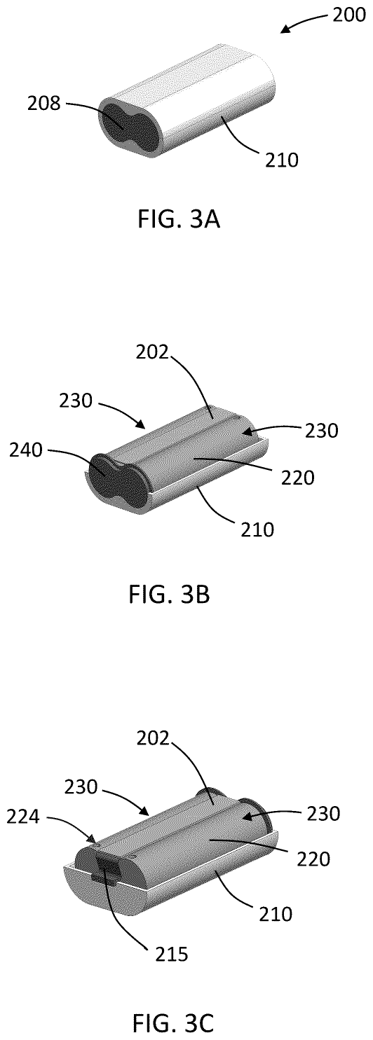

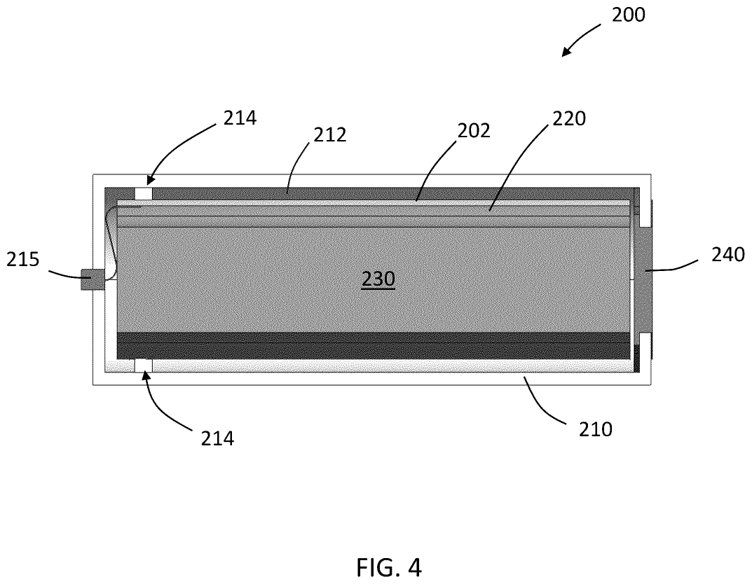

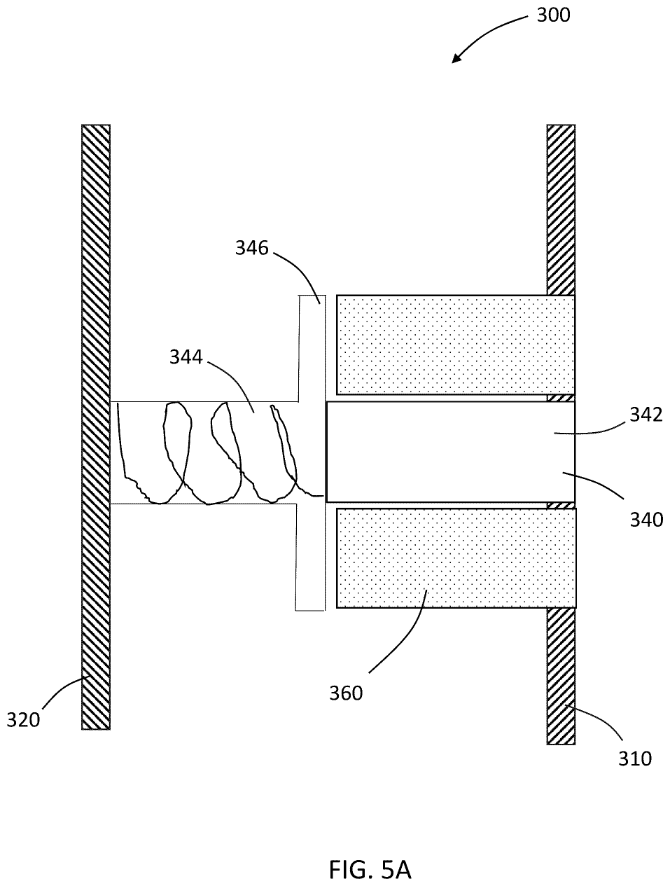

FIGS. 3A-3C and FIG. 4 show a battery 200 that includes two electrochemical cells 230, enclosed in a cell housing 220 (corresponding to inner shell 120 depicted in FIGS. 1A-B). It will be understood that a battery 200 may include any suitable number of electrochemical cells 230. A battery 200 containing more than one electrochemical cell 230 may be referred to as a battery back. Each electrochemical cell 230 in the battery 200 is housed within an external housing 210 (corresponding to outer shell 110 as depicted in FIGS. 1A-1B). Each electrochemical cell 230 in the battery 200 may be wired, connected, or otherwise coupled to another electrochemical cell 230 via an electronic circuit 202, where the electronic circuit 202 may connect each electrochemical cell 230 within the battery 200 in parallel, series, or in other desired combinations. Additionally, electronic circuit 202 may be configured to prevent over current, over voltage, under voltage, control charging, prevent over-temperature situations during charging, etc. Such configurations are conventionally known and therefore omitted from description.

External housing 210 may be in contact with cell housing 220. Alternately, there may be an air gap between the external housing 210 and cell housing 220 within the battery 200 such that minimal or no contact is made between cell housing 220 disposed within the external housing 210. In the depicted embodiment, a plurality of electrochemical cells 230 are housed withing a single cell housing 220. However, it will be understood that electrochemical cells 230 or groups of electrochemical cells 230 may be disposed in more than one cell housing 220 in a battery 200.

Thermally conductive pin 240 (corresponding to the thermally conductive pin 140 depicted in FIGS. 1A-1B) may be configured such that the pin 240 separates from cell housing 220 at any suitable temperature. For example, the battery 200 may be configured such that the pin 240 separates from cell housing 220 when the battery 200 is exposed over a period of time to an external temperature of 85 degrees C. or greater. Example external temperatures which may trigger such separation may include at least an external temperature of 90 degrees C. or greater, 95 degrees C. or greater, 100 degrees C. or greater, 105 degrees C. or greater, 110 degrees C. or greater, 115 degrees C. or greater, or 120 degrees C. or greater.

The pin 240 may be fixed relative to external housing 210, which has a thermal coefficient of expansion (CTE) greater than the CTE of the cell housing 220. As external temperatures increase, the external housing 210 expands more rapidly than the cell housing 220 causing the pin 240 to separate from the cell housing 220. As external temperatures decrease from elevated temperature, the external housing 210 contracts more rapidly than the cell housing 220 causing the pin 240 to recontact the cell housing 220 and thermally couple the cell housing 220 and the external housing 210.

Battery 200 can further include an interconnect 215 electrically coupled to electronic circuit 202. Interconnect 215 may be used to electronically connect battery 200 to external elements or devices. Interconnect 215 may be flexible to maintain connection with the circuit 202 as the external housing 210 expands when exposed to elevated temperatures or contracts when exposed to lowered external temperatures.

The cell housing 220 may define receptacles 224 for receiving key posts of external housing 210, e.g., as described in more detail regarding FIG. 4.

FIG. 4 represents a cross-sectional view of an embodiment of the battery 200 depicted in FIGS. 3A-C. In embodiments a gap exists between the external housing 210 and the cell housing 220. In embodiments, an insulative layer 212 is disposed between the external housing 210 and the cell housing 220. The thermally insulative layer 212 may be comprised of any suitable material that insulates against heat transfer. Examples of suitable materials that insulate against heat transfer include wax, fiberglass, Styrofoam, and wool. In some embodiments, the insulative layer 212 comprises silica (silicon dioxide) or silica ceramic carbon nitride, either solid, woven, fibers or in other forms. In some embodiments, the insulative layer 212 may comprise an aerogel, such as for example silica aerogel. Aerogels provide strong protection and insulative properties against most methods of heat transfer (e.g., convection, conduction, and radiation).

In FIG. 4, the external housing 210 includes key posts 214. The key posts 214 may be received by corresponding receptacles in the cell housing 220 (see, e.g., receptable 224 in FIG. 3C) to orient the external housing 210 relative to the cell housing 220. The key posts 214 position the majority of the external housing 210 away from the cell housing 220 such that an air gap is formed between the external housing 220 and the cell housing 210 or may provide sufficient space for insertion of insulative layer 212 between the external housing 220 and the cell housing.

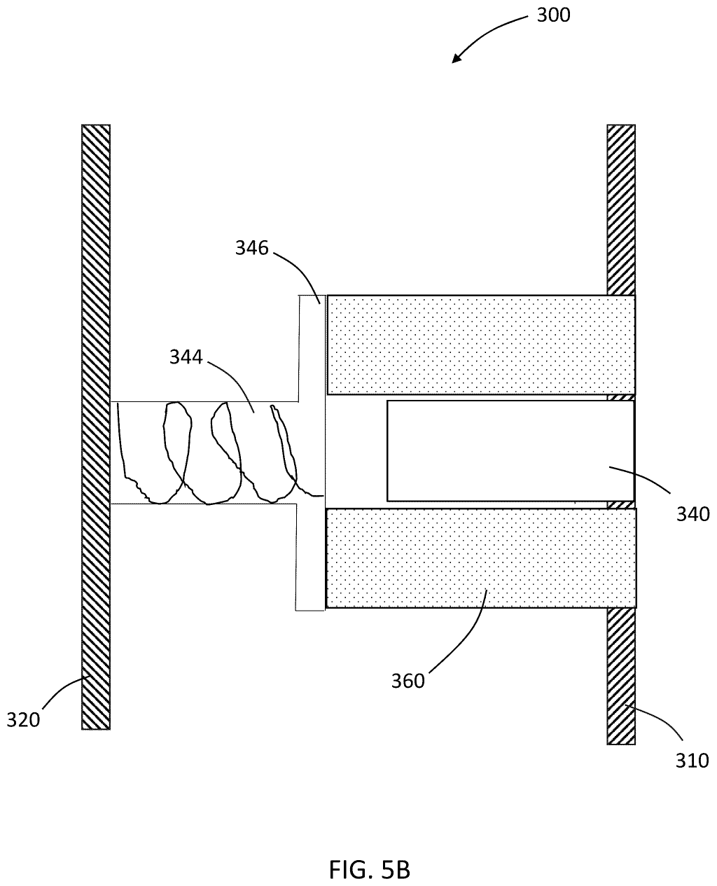

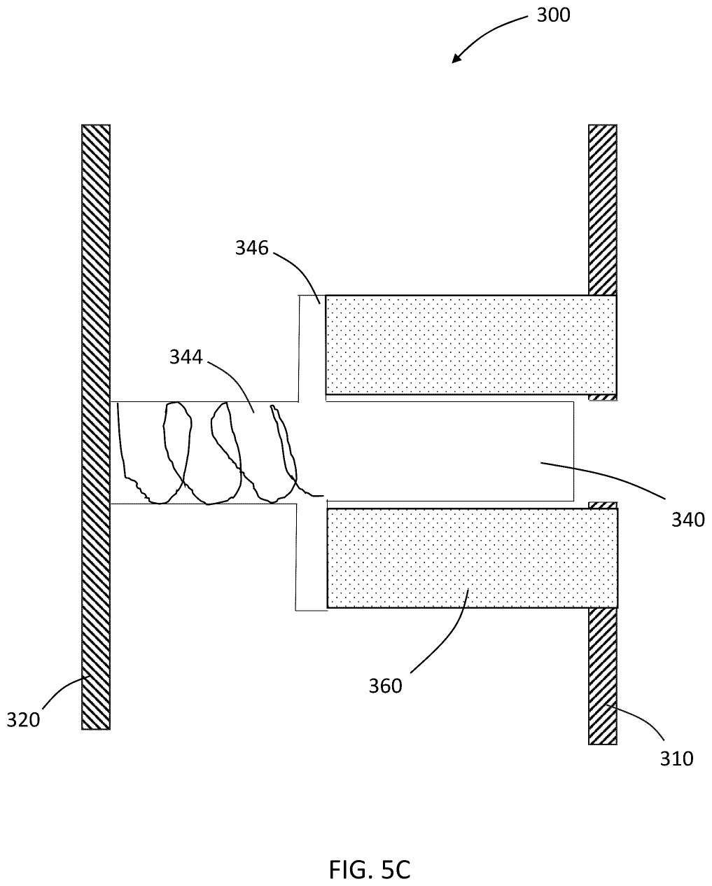

FIGS. 5A-5C are schematic representations of a battery 300 which include at least a thermally conducive inner shell 320, a thermally conductive outer shell 310, and a thermally conductive pin 340. An electrochemical cell (not shown) is disposed in the inner shell 320. The pin 340 may comprise a thermally conductive spring 344 (e.g., as shown in FIG. 5C). Alternately, the pin 340 may be detachably coupled to the thermally conductive spring 344 (e.g., as shown in FIG. 5B). The pin 340 or the spring 344 comprises a flange 346.

The outer shell 310 is formed of a material with a first CTE. The inner shell 320 may be formed of a material having a second CTE which is lower than the first CTE. Alternately, the inner shell 320 may be formed of a material having a second CTE which is similar to or the same as the first CTE.

The battery 300 comprises an expansion element 360 having a CTE greater than the first and second CTEs. The expansion element 360 is fixed relative to the outer shell 310 and extends towards the inner shell 320. As the temperature exterior to the battery 300 increases, the expansion element expands and presses against flange 346 causing the spring portion 344 to separate from the pin 340 (as depicted in FIG. 5B) or causing the pin 340 to separate from the outer shell 320 (as depicted in FIG. 5C).

The expansion element 360 may be formed of any suitable relatively non-thermally conductive element having a relatively high CTE. Examples of such suitable materials include polymeric materials. In some embodiments, the expansion element 360 is formed from one or more plastic materials. In some embodiments, expansion element 360 comprises polycarbonate, acrylonitrile butadiene styrene, or a combination thereof. In some embodiments, the expansion element 360 comprises any of acrylonitrile butadiene styrene (ABS), acetals, acrylic, benzocylcobutene, cellulose acetate (CA), cellulose acetate butynate (CA B), cellulose nitrate (CN), fluorinated ethylene propylene (FEP), nylon, polyacrylonitrile, polyamide (PA), polybutylene (PB), polycarbonate (PC), polyester, polyethylene terephthalate (PET), polyphenylene, polystyrene, polytetrafluoroethylene (PFTE), polyurethane, polyvinylchloride, polyvinylidene fluoride, polyimide (PI), polyphenylene sulfide (PPS), polyaryletherketone (PAEK), polyetheretherketone (PEEK).

In some embodiments, the expansion element 360 is formed from material having a thermal conductivity of at least 5 W/mK, such as 240 W/mK (e.g., aluminum), or 400 W/mK (e.g., copper). In some embodiments, the CTE of the expansion element at least 20 μm/m° C. In some embodiments, the expansion element 360 has a CTE in a range from at least 60 μm/m° C. to 400 μm/m° C., such as, for example, PC/ABS, which has a CTE value of 60 82 m/m° C.

The thermally conductive pin 340 may fixed relative to the outer shell 310 (e.g., as shown in FIG. 5B) or may be moveable relative to the outer shell 310 (e.g., as shown in FIG. 5C). The pin 340 is positioned to thermally couple the inner shell 320 to the outer shell 310 at a first ambient temperature as depicted in FIG. 5A. The spring or spring portion 344 of the spring 340 is fixed relative to the inner shell 320. The spring 344 may be detachably coupled to the pin 340 as shown in FIG. 5B as the expansion member 360 expands at elevated temperatures. Alternately, the spring 340 may be fixed relative the inner shell 320 and configured to detachably couple to the outer shell 310 as shown in FIG. 5C as the expansion member 360 expands at elevated temperatures.

As ambient temperature decreases the expansion member 360 retracts, allowing the flange 346 of the spring element 344 to reconnect with the pin 340 (e.g., as shown in FIG. 5B) or allowing the pin 340 to reconnect with the outer shell 310 (e.g., as shown in FIG. 5C).

Accordingly, at least the thermally conductive pin 340 is in thermal contact with the outer shell 310 and the inner shell 320 when the battery 300 is exposed to ambient temperatures and transfers internal heat generated by an electrochemical cell during use or recharge to the external environment (outside of outer shell 310). When the battery 300 is exposed to elevated external temperatures, the pin 340 either separates from the external shell 310 (e.g., as shown in FIG. 5C) or decouples from spring element 344 (e.g., as shown in FIG. 5B) so that external heat is not transferred directly to the internal shell 320, protecting the inner electrochemical cell from the external heat.

The battery 300 may be configured such that the pin 340 separates from the external shell 310 or decouples from the spring portion 344 at any suitable temperature. For example, the battery 300 may be configured such that the pin 340 separates from the external shell 310 or decouples from the spring portion 344 when the battery 100 is exposed over a period of time to an external temperature of 85 degrees C. or greater. Example external temperatures which may trigger such separation may include at least an external temperature of 90 degrees C. or greater, 95 degrees C. or greater, 100 degrees C. or greater, 105 degrees C. or greater, 110 degrees C. or greater, 115 degrees C. or greater, or 120 degrees C. or greater.

As the external temperature to which the battery 300 is exposed decreases (e.g., the temperature decreases to 120 degrees C. or less, 115 degrees C. or less, 110 degrees C. or less, 105 degrees C. or less, 100 degrees C. or less, 95 degrees C. or less, 90 degrees C. or less, or 85 degrees C. or less), the expansion member 360 may retract, allowing the flange 346 of the spring element 344 to reconnect with the pin 340 (e.g., as shown in FIG. 5B) or allowing the pin 340 to reconnect with the outer shell 310 (e.g., as shown in FIG. 5C). When the pin is coupled with the outer shell 310 or the spring element 344, internal heat generated by the inner electrochemical cell may be transferred to the external environment.

In the embodiments depicted in FIGS. 5A-C, the outer shell 310 may have any suitable coefficient of thermal expansion (CTE). In some embodiments, the outer shell 310 has a CTE in a range from 20 μm/m° C. to 400 μm/m° C., such as at least 60 μm/m° C. to 400 μm/m° C., such as, for example, PC/ABS, which has a CTE value of 60 μm/m° C. Any suitable material can comprise the outer shell 310.

In the embodiments depicted in FIGS. 5A-C, the outer shell 310 and the inner shell 320 may have any suitable thermal conductivity. In some embodiments, the outer shell 310 and the inner shell 320 are formed from materials having the same or similar thermally conductivities. In some embodiments, the outer shell 310 has a thermal conductivity of 5 W/mk or above. In some embodiments, the outer shell 110 has a thermal conductivity of at least 237 W/mK (e.g., aluminum). In some embodiments, the outer shell 310 has a thermal conductivity of at least 400 W/mK (e.g., copper). In some embodiments, the inner shell 320 has a thermal conductivity in the range between approximately 14 W/mK to 20 W/mK (e.g., stainless steel). In some embodiments, the inner shell 320 has a thermal conductivity of approximately 90 W/mK (e.g., nickel).

In the embodiments depicted in FIGS. 5A-C, the pin 340 and/or spring element 344 may have any suitable thermal conductivity. In some embodiments, the pin 340 and/or spring element 344 has a thermal conductivity of 10 W/mK or greater, such as at least between 20 W/mk and 400 W/mK. In some embodiments, the pin 340 and/or spring element 344 has a thermal conductivity of at least 1 W/mK greater than the thermal conductivity of the inner shell 320.

In the embodiments depicted in FIGS. 5A-C, the outer shell 310 may be formed from any suitable material. In some embodiments, the outer shell 310 is formed from one or more polymeric materials. In some embodiments, the outer shell 310 is formed from one or more plastic materials. In some embodiments, outer shell 310 comprises polycarbonate, acrylonitrile butadiene styrene, or a combination thereof. In some embodiments, the outer shell 310 comprises Any of acrylonitrile butadiene styrene (ABS), acetals, acrylic, benzocylcobutene, cellulose acetate (CA), cellulose acetate butynate (CA B), cellulose nitrate (CN), fluorinated ethylene propylene (FEP), nylon, polyacrylonitrile, polyamide (PA), polybutylene (PB), polycarbonate (PC), polyester, polyethylene terephthalate (PET), polyphenylene, polystyrene, polytetrafluoroethylene (PFTE), polyurethane, polyvinylchloride, polyvinylidene fluoride, polyimide (PI), polyphenylene sulfide (PPS), polyaryletherketone (PAEK), polyetheretherketone (PEEK), and combinations thereof.

In the embodiments depicted in FIGS. 5A-C, the inner shell 320 may be formed from any suitable material. In some embodiments, the inner shell 320 is formed from one or more metallic materials. In some embodiments, the inner shell 320 is formed from aluminum. In some embodiments, the inner shell 320 is formed from aluminum nitride.

The pin 340 may be formed from any suitable material. In some embodiments, the pin 340 is formed from a material having a thermal conductivity of 10 W/mK or greater. In some embodiments, the pin 340 is formed from a material having a thermal conductivity of between 20 W/mK and 400 W/mK. In some embodiments, the pin 306 comprises copper.

The spring 344 may be formed from any suitable material. In some embodiments, the spring 344 is formed from a material having a thermal conductivity of 10 W/mK or greater. In some embodiments, the spring 344 is formed from a material having a thermal conductivity of between 20 W/mK and 400 W/mK, such as, for example, any suitable metal or metal alloy. In some embodiments, the spring 344 has a Spring Constant of between a suitable threshold range. In some embodiments, the spring 344 has a Spring Constant of 263 N/m or greater.

All scientific and technical terms used herein have meanings commonly used in the art unless otherwise specified. The definitions provided herein are to facilitate understanding of certain terms used frequently herein and are not meant to limit the scope of the present disclosure.

As used herein, singular forms “a,” “an” and “the” include plural referents unless the context clearly dictates otherwise. As used in this specification and the appended claims, the term “or” is generally employed in its sense including “and/or” unless the content clearly dictates otherwise. The term “and/or” means one or all of the listed elements or a combination of any two or more of the listed elements.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the inventive technology.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

The techniques of this disclosure may also be described in the following examples.

### EXAMPLE

Various examples of the disclosure have been described. These and other examples are within the scope of the following claims.

Example 1: A battery comprising: a thermally conductive outer shell formed from a first material having a first coefficient of thermal expansion (CTE); a thermally conductive inner shell disposed in the outer shell, wherein the inner shell is formed of a second material having a second CTE lower than the first CTE; an electrochemical cell disposed in the inner shell; and a thermally conductive pin fixed relative to the outer shell and positioned to couple to the inner shell at a first ambient temperature, wherein the battery is configured such that as ambient temperature increases the outer shell (i) expands to a greater degree than the inner shell, (ii) separates from the inner shell, and (iii) pulls the pin away from the inner shell.

Example 2: The battery of claim 1, wherein: the battery is configured such that as ambient temperature decreases the outer shell (i) retracts to a greater degree than the inner shell, (ii) moves closer to the inner shell, and (iii) pushes the pin toward the inner shell.

Example 3: The battery of claim 1 or 2, wherein the battery is configured such that the pin thermally couples the outer shell to the inner shell at ambient temperatures of 100 degrees Celsius and below.

Example 4: The battery of any of claims 1 to 3, wherein the battery is configured such that expansion of the outer shell causes the pin to separate from the inner shell at ambient temperatures of greater than 100 degrees Celsius.

Example 5: The battery of any of claims 1 to 4, wherein a thermally conductive spring is coupled to the outer shell such that, as ambient temperature increases, the outer shell (i) expands, (ii) pulses against the spring, (iii) separates from the inner shell, and (iv) pulls the pin away from the inner shell.

Example 6: The battery of claim 5, wherein, as ambient temperature decreases, the outer shell (i) retracts, (ii) moves closer to the inner shell, and (iii) pushes the pin toward the inner shell.

Example 7: The battery of any of claims 1 to 6, wherein a thermally conductive spring is coupled to the inner shell such that, as ambient temperature increases, (i) the outer shell expands, pulsing the pin against the spring, (ii) separates from the inner shell, and (iii) pulls the pin away from the inner shell.

Example 8: The battery of any of claims 1 to 7, wherein, as ambient temperature decreases, the outer shell (i) retracts, (ii) couples to the inner shell, and (iii) pushes the pin toward the inner shell.

Example 9: The battery of any of claims 1 to 8, further comprising a thermally insulative layer disposed about the outer housing.

Example 10: The battery of any of claims 1 to 9, further comprising at least one connection terminal electronically accessible from outside the enclosure.

Example 11: The battery of any of claims 1 to 10, wherein the first CTE is at least 1 um/m° C. greater than the second CTE.

Example 12: The battery of any of claims 1 to 11, wherein the first material can comprise any of following materials: polycarbonate, acrylonitrile butadiene styrene, acrylonitrile butadiene styrene (ABS), acetals, acrylic, benzocylcobutene, cellulose acetate (CA), cellulose acetate butynate (CAB), cellulose nitrate (CN), fluorinated ethylene propylene (FEP), nylon, polyacrylonitrile, polyamide (PA), polybutylene (PB), polycarbonate (PC), polyester, polyethylene terephthalate (PET), polyphenylene, polystyrene, polytetrafluoroethylene (PFTE), polyurethane, polyvinylchloride, polyvinylidene fluoride, polyimide (PI), polyphenylene sulfide (PPS), polyaryletherketone (PAEK), polyetheretherketone (PEEK), and any combination thereof.

Example 13: The battery of any of claims 1 to 12, wherein the second material can comprise any of the following materials: aluminum, aluminum nitride, aluminum alloy, silicon carbide, ALLVAR Alloy 30, titanium, titanium alloy, stainless steel, nickel, nickel alloy, a ceramic material, a plastic, and any combination thereof.

Example 14: The battery of any of claims 1 to 13, wherein the CTE of the first material can be between 20 μm/m° C. and 400 μm/m° C.

Example 15: The battery of any of claims 1 to 14, wherein the CTE of the second material can be between −20 μm/m° C. and 20 μm/m° C.

Example 16: A battery, comprising: a thermally conductive outer shell formed from a first material having a first coefficient of thermal expansion (CTE); a thermally conductive inner shell disposed in the outer shell formed from a second material having a second CTE; an electrochemical cell disposed in the inner shell; a thermally conductive pin coupled to the outer shell; a spring coupled to the inner shell; at least a first non-thermally conductive expansion element fixed relative to the outer shell and configured to expand toward the inner shell having a third CTE, wherein the third CTE is greater than the first CTE and second CTE; and a flange, configured to couple the pin, the expansion element, and the spring at a first ambient temperature, such that the resulting coupling couples the inner shell to the outer shell; wherein the battery is configured such that as ambient temperature increases the expansion element (i) expands, (ii) presses against the flange, (iii) causes the spring to separate from the pin, and (iv) uncouples the inner shell from the outer shell.

Example 17: The battery of claim 16, wherein the battery is configured such that as ambient temperature decreases the expansion element (i) retracts to a greater degree than the inner shell and the outer shell (ii) moves the pin closer to the spring, and (iii) couples the spring to the pin.

Example 18: The battery of claim 16 or 17, wherein the battery is configured such that the pin thermally couples to the spring at ambient temperatures of 100 degrees Celsius and below.

Example 19: The battery of any of claims 16 to 18, wherein the battery is configured such that expansion of the outer shell causes the pin to separate from the spring at ambient temperatures of greater than 100 degrees Celsius.

Example 20: The battery of any of claims 16 to 19, further comprising a thermally insulative layer disposed about the outer housing.

Example 21: The battery of any of claims 16 to 20, further comprising at least one connection terminal electronically accessible from outside the enclosure.

Example 22: The battery of any of claims 16 to 21, wherein the first CTE is at least 1 μm/m° C. greater than the second CTE.

Example 23: The battery of any of claims 16 to 21, wherein the first CTE is the same as the second CTE.

Example 24: The battery of any of claims 16 to 23, wherein the first material can comprise any of following materials: polycarbonate, acrylonitrile butadiene styrene, acrylonitrile butadiene styrene (ABS), acetals, acrylic, benzocylcobutene, cellulose acetate (CA), cellulose acetate butynate (CAB), cellulose nitrate (CN), fluorinated ethylene propylene (FEP), nylon, polyacrylonitrile, polyamide (PA), polybutylene (PB), polycarbonate (PC), polyester, polyethylene terephthalate (PET), polyphenylene, polystyrene, polytetrafluoroethylene (PFTE), polyurethane, polyvinylchloride, polyvinylidene fluoride, polyimide (PI), polyphenylene sulfide (PPS), polyaryletherketone (PAEK), polyetheretherketone (PEEK), and any combination thereof.

Example 25: The battery of any of claims 16 to 24, wherein the second material can comprise any of the following materials: aluminum, aluminum nitride, aluminum alloy, silicon carbide, ALLVAR Alloy 30, titanium, titanium alloy, stainless steel, nickel, nickel alloy, a ceramic material, a plastic, and any combination thereof.

Example 26: The battery of any of claims 16 to 25, wherein the CTE of the first material can be between 20 μm/m° C. and 400 μm/m° C.

Example 27: The battery of any of claims 16 to 26, wherein the CTE of the second material can be between −20 μm/m° C. and 20 μm/m° C.

Example 28: The battery of any of claims 16 to 27, wherein the CTE of the expansion element can be between −10 μm/m° C. and 400 μm/m° C.

Example 29: The battery of any of claims 16 to 28, wherein the pin comprises the flange.

Example 30: The battery of any of claims 16 to 28, wherein the spring comprises the flange.

Example 31: The battery of any of claims 16 to 30, wherein the pin is detachably coupled to the outer shell.

Example 32: The battery of any of claims 16 to 30, wherein the pin is fixed relative to the outer shell.

Example 33: The battery of any of claims 16 to 32, wherein the spring is detachably coupled to the inner shell.

Example 34: The battery of any of claims 16 to 32, wherein the spring is fixed relative to the inner shell.

Example 35: A battery, comprising: a thermally conductive outer shell formed from a first material having a first coefficient of thermal expansion (CTE); a thermally conductive inner shell disposed in the outer shell formed from a second material having a second CTE; an electrochemical cell disposed in the inner shell; a thermally conductive pin detachably coupled to the outer shell; a spring portion coupled to the inner shell; at least a first non-thermally conductive expansion element fixed relative to the outer shell and configured to expand toward the inner shell having a third CTE, wherein the third CTE is greater than the first CTE and second CTE; and a flange, configured to couple the pin, the expansion element, and the spring portion at a first ambient temperature, such that the resulting coupling couples the inner shell to the outer shell; wherein the battery is configured such that as ambient temperature increases the expansion element (i) expands, (ii) presses against the flange, (iii) causes the pin to separate from the outer shell, and (iv) uncouples the inner shell from the outer shell.

Example 36: The battery of claim 35, wherein the battery is configured such that as ambient temperature decreases the expansion element (i) retracts to a greater degree than the inner shell and the outer shell (ii) moves the pin closer to the outer shell, and (iii) couples the spring to the outer shell.

Example 37: The battery of claim 35 or 36, wherein the battery is configured such that the pin thermally couples to the outer shell at ambient temperatures of 100 degrees Celsius and below.

Example 38: The battery of any of claims 35 to 37, wherein the battery is configured such that expansion of the outer shell causes the pin to separate from the outer shell at ambient temperatures of greater than 100 degrees Celsius.

Example 39: The battery of any of claims 35 to 38, further comprising a thermally insulative layer disposed about the outer housing.

Example 40: The battery of any of claims 35 to 39, further comprising at least one connection terminal electronically accessible from outside the enclosure.

Example 41: The battery of any of claims 35 to 40, wherein the first CTE is at least 1 μm/m° C. greater than the second CTE.

Example 42: The battery of any of claims 35 to 40, wherein the first CTE is the same as the second CTE.

Example 43: The battery of any of claims 35 to 42, wherein the first material can comprise any of following materials: polycarbonate, acrylonitrile butadiene styrene, acrylonitrile butadiene styrene (ABS), acetals, acrylic, benzocylcobutene, cellulose acetate (CA), cellulose acetate butynate (CAB), cellulose nitrate (CN), fluorinated ethylene propylene (FEP), nylon, polyacrylonitrile, polyamide (PA), polybutylene (PB), polycarbonate (PC), polyester, polyethylene terephthalate (PET), polyphenylene, polystyrene, polytetrafluoroethylene (PFTE), polyurethane, polyvinylchloride, polyvinylidene fluoride, polyimide (PI), polyphenylene sulfide (PPS), polyaryletherketone (PAEK), polyetheretherketone (PEEK), and any combination thereof.

Example 44: The battery of any of claims 35 to 43, wherein the second material can comprise any of the following materials: aluminum, aluminum nitride, aluminum alloy, silicon carbide, ALLVAR Alloy 30, titanium, titanium alloy, stainless steel, nickel, nickel alloy, a ceramic material, a plastic, and any combination thereof.

Example 45: The battery of any of claims 35 to 44, wherein the CTE of the first material can be between 20 μm/m° C. and 400 μm/m° C.

Example 46: The battery of any of claims 35 to 45, wherein the CTE of the second material can be between −20 μm/m° C. and 20 μm/m° C.

Example 47: The battery of any of claims 35 to 46, wherein the pin comprises the flange.

Example 48: The battery of any of claims 35 to 46, wherein the spring comprises the flange.

Example 49: The battery of any of claims 35 to 48, wherein the pin is detachably coupled to the outer shell.

Example 50: The battery of any of claims 35 to 48, wherein the pin is fixed relative to the outer shell.

Example 51: The battery of any of claims 35 to 50, wherein the spring is detachably coupled to the inner shell.

Example 52: The battery of any of claims 35 to 50, wherein the spring is fixed relative to the inner shell.

Example 53: The battery of any of claims 35 to 52, wherein the pin comprises the spring portion.

What is claimed is:

1. A battery comprising:
a thermally conductive outer shell formed from a first material having a first coefficient of thermal expansion (CTE);
a thermally conductive inner shell disposed in the outer shell, wherein the inner shell is formed of a second material having a second CTE lower than the first CTE;
an electrochemical cell disposed in the inner shell; and
a thermally conductive pin fixed relative to the outer shell and positioned to couple to the inner shell at a first ambient temperature,
wherein the battery is configured such that as ambient temperature increases the outer shell (i) expands to a greater degree than the inner shell, (ii) separates from the inner shell, and (iii) pulls the pin away from the inner shell.

2. The battery of claim 1, wherein:
the battery is configured such that as ambient temperature decreases the outer shell (i) retracts to a greater degree than the inner shell, (ii) moves closer to the inner shell, and (iii) pushes the pin toward the inner shell.

3. The battery of claim 1, wherein the battery is configured such that the pin thermally couples the outer shell to the inner shell at ambient temperatures of 100 degrees Celsius and below.

4. The battery of claim 1, wherein the battery is configured such that expansion of the outer shell causes the pin to separate from the inner shell at ambient temperatures of greater than 100 degrees Celsius.

5. The battery of claim 1, wherein a thermally conductive spring is coupled to the outer shell such that, as ambient temperature increases, the outer shell (i) expands, (ii) pulses against the spring, (iii) separates from the inner shell, and (iv) pulls the pin away from the inner shell.

6. The battery of claim 5, wherein, as ambient temperature decreases, the outer shell (i) retracts, (ii) moves closer to the inner shell, and (iii) pushes the pin toward the inner shell.

7. The battery of claim 1, wherein a thermally conductive spring is coupled to the inner shell such that, as ambient temperature increases, (i) the outer shell expands, pulsing the pin against the spring, (ii) separates from the inner shell, and (iii) pulls the pin away from the inner shell.

8. The battery of claim 1, wherein, as ambient temperature decreases, the outer shell (i) retracts, (ii) couples to the inner shell, and (iii) pushes the pin toward the inner shell.

9. The battery of claim 1, further comprising a thermally insulative layer disposed about the outer shell.

10. The battery of claim 1, wherein the first CTE is at least 1 μm/m° C. greater than the second CTE.

11. The battery of claim 1, wherein the first material comprises polycarbonate, acrylonitrile butadiene styrene, acrylonitrile butadiene styrene (ABS), acetals, acrylic, benzocylcobutene, cellulose acetate (CA), cellulose acetate butynate (CAB), cellulose nitrate (CN), fluorinated ethylene propylene (FEP), nylon, polyacrylonitrile, polyamide (PA), polybutylene (PB), polycarbonate (PC), polyester, polyethylene terephthalate (PET), polyphenylene, polystyrene, polytetrafluoroethylene (PFTE), polyurethane, polyvinylchloride, polyvinylidene fluoride, polyimide (PI), polyphenylene sulfide (PPS), polyaryletherketone (PAEK), polyetheretherketone (PEEK), or any combination thereof.

12. The battery of claim 1, wherein the second material comprises aluminum, aluminum nitride, aluminum alloy, silicon carbide, ALLVAR Alloy 30, titanium, titanium alloy, stainless steel, nickel, nickel alloy, a ceramic material, a plastic, or any combination thereof.

13. The battery of claim 1, wherein the CTE of the first material is between 20 μm/m° C. and 400 μm/m° C.

14. The battery of claim 1, wherein the CTE of the second material is between 31 20 μm/m° C. and 20 μm/m° C.

15. A battery, comprising:
a thermally conductive outer shell formed from a first material having a first coefficient of thermal expansion (CTE);
a thermally conductive inner shell disposed in the outer shell formed from a second material having a second CTE;
an electrochemical cell disposed in the inner shell;
a thermally conductive pin coupled to the outer shell;
a spring coupled to the inner shell;
at least a first non-thermally conductive expansion element fixed relative to the outer shell and configured to expand toward the inner shell having a third CTE, wherein the third CTE is greater than the first CTE and second CTE; and
a flange, configured to couple the pin, the expansion element, and the spring at a first ambient temperature, such that the resulting coupling couples the inner shell to the outer shell;
wherein the battery is configured such that as ambient temperature increases the expansion element (i) expands, (ii) presses against the flange, (iii) causes the spring to separate from the pin, and (iv) uncouples the inner shell from the outer shell.

16. The battery of claim 15, wherein the battery is configured such that as ambient temperature decreases the expansion element (i) retracts to a greater degree than the inner shell and the outer shell (ii) moves the pin closer to the spring, and (iii) couples the spring to the pin.

17. The battery of claim 15, wherein the pin is detachably coupled to the outer shell.

18. The battery of claim 15, wherein the pin is fixed relative to the outer shell.

19. The battery of claim 15, wherein the spring is detachably coupled to the inner shell.

20. The battery of claim 15, wherein the spring is fixed relative to the inner shell.
